(19) United States
(12) Patent Application Publication
(10) Pub. No.: US 2026/0067556 A1
(43) Pub. Date: Mar. 5, 2026

(54) IMAGE PICKUP APPARATUS CAPABLE OF OBTAINING PHOTOGRAPHED IMAGE FOCUSED ON PART DESIRED BY PHOTOGRAPHER WHEN PHOTOGRAPHING PLURALITY OF SUBJECTS AT DIFFERENT POSITIONS IN DEPTH DIRECTION, CONTROL METHOD FOR IMAGE PICKUP APPARATUS, AND STORAGE MEDIUM

(71) Applicant: CANON KABUSHIKI KAISHA, Tokyo (JP)

(72) Inventors: TAKEO SUGA, Kanagawa (JP); NOBUTAKA MIZUNO, Tokyo (JP); YUMI TAKAO, Chiba (JP)

(21) Appl. No.: 19/308,708

(22) Filed: Aug. 25, 2025

(30) Foreign Application Priority Data
Sep. 2, 2024 (JP) 2024-150807

(51) Int. Cl. H04N 23/61; H04N 23/67; H04N 25/705

(52) U.S. Cl. CPC H04N 23/61; H04N 23/671; H04N 23/675; H04N 25/705

(57) ABSTRACT

An image pickup apparatus capable of obtaining a photographed image focused on a desired part is provided. The image pickup apparatus includes at least one processor and/or circuit configured to function as a unit that detects predetermined subjects from an image obtained by an image pickup unit, a unit that hierarchically detects characteristic regions of each predetermined subject, a unit that selects two subjects different in a distance from the image pickup unit in a depth direction, a unit that determines a focus area, a unit that sets an aperture value and a focal position that keep parts corresponding to the focus areas within a range of a depth of field, and a unit that predicts positions of the two subjects after a predetermined period of time has elapsed based on subject image plane positions obtained by past focus detection and defocus amounts obtained by the most recent focus detection.

### BACKGROUND

### Field of the Technology

The present disclosure relates to an image pickup apparatus, a control method for the image pickup apparatus, and a storage medium.

### Description of the Related Art

Generally, when photographing a plurality of subjects at different positions in a depth direction or a subject that is long in the depth direction, in order to widen (increase) a depth of field, an aperture of a lens device is often narrowed (an aperture value (an F-number) is often increased). Although this method increases the depth of field, if the aperture is narrowed too much, an out-of-focus effect will be impaired. In addition, in the case of attempting to clearly photograph a moving subject, since it is necessary to increase a shutter speed (shorten a shutter time), in order to obtain a required amount of exposure, it may not be possible to narrow the aperture to a desired value.

In view of this, Japanese Patent No. 6253454 has proposed an image pickup apparatus equipped with a scene mode suitable for an image pickup situation in which a plurality of moving subjects are to be picked up. Specifically, in a technique (the image pickup apparatus) disclosed in Japanese Patent No. 6253454, first, characteristic parts of a plurality of subjects that have been detected from an image obtained by an image pickup optical system are detected, and positions of a plurality of the characteristic parts after a predetermined period of time has elapsed are predicted by comparing changes in positions of the plurality of the characteristic parts in the depth direction between the latest image and an image immediately before the latest image. Then, in the technique disclosed in Japanese Patent No. 6253454, in accordance with predicted position information for the plurality of the characteristic parts and a focal length of the image pickup optical system, a depth of field that is capable of bringing the plurality of the characteristic parts into an in-focus state within the image is set.

In the technique disclosed in Japanese Patent No. 6253454, the depth of field has been set with respect to subjects at different positions in the depth direction. In this case, in the technique disclosed in Japanese Patent No. 6253454, since a plurality of parts of the subjects are not hierarchically recognized, it may not be possible to obtain a photographed image reliably focused on a part desired by a photographer.

### SUMMARY

The present disclosure provides an image pickup apparatus capable of obtaining a photographed image focused on a part desired by a photographer when photographing a plurality of subjects at different positions in a depth direction, a control method for the image pickup apparatus, and a storage medium.

Accordingly, a first aspect of the present disclosure provides an image pickup apparatus comprising at least one processor and/or circuit configured to function as a subject detecting unit that detects predetermined subjects from an image obtained by an image pickup unit including an image pickup optical system, a region detecting unit that hierarchically detects characteristic regions of each of the predetermined subjects, a selecting unit that selects, from among the predetermined subjects, two subjects that are different in a distance from the image pickup unit in a depth direction, a determining unit that determines a focus area from among regions hierarchically detected for each of the two subjects, a control unit that sets an aperture value and a focal position that keep parts of the two subjects corresponding to the focus areas selected by the determining unit within a range of a depth of field, and a predicting unit that predicts positions of the two subjects in the depth direction after a predetermined period of time has elapsed based on subject image plane positions obtained by past focus detection for the two subjects and defocus amounts obtained by the most recent focus detection for the two subjects.

Accordingly, a second aspect of the present disclosure provides an image pickup apparatus comprising at least one processor and/or circuit configured to function as a subject detecting unit that detects predetermined subjects from an image obtained by an image pickup unit including an image pickup optical system, a region detecting unit that hierarchically detects characteristic regions of each of the predetermined subjects, a selecting unit that selects, from among the predetermined subjects, two subjects that are different in a distance from the image pickup unit in a depth direction, a determining unit that determines a focus area from among regions hierarchically detected for each of the two subjects, and a control unit that shifts a focal position when focusing on the focus area of a close-range subject of the two subjects toward a distant-range subject side and obtains a minimum aperture value at which the two subjects are within a range of a depth of field.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a schematic configuration of an image pickup apparatus according to an embodiment.

FIG. 2A and FIG. 2B are plan views for explaining a configuration of an image pickup device included in the image pickup apparatus, and FIG. 2C is a sectional view for explaining the configuration of the image pickup device.

FIG. 3 is a view for explaining a relationship between the image pickup device and an exit pupil plane.

FIG. 4 is a flowchart of a photographing operation according to a first embodiment, which is performed by the image pickup apparatus.

FIG. 5 is a flowchart of a subject determination processing performed in S102 of FIG. 4.

FIG. 6A and FIG. 6B are schematic diagrams that illustrate a hierarchical detection of characteristic regions, which is performed in S201 of FIG. 5.

FIG. 7 is a flowchart of an aperture and focal position adjustment processing performed in S105 of FIG. 4.

FIG. 8A and FIG. 8B are diagrams that illustrate an example of a photographing scene.

FIG. 9 is a diagram that illustrates a relationship between an F-number, a focal position, and a depth of field in the photographing scene that is shown in FIG. 8A and FIG. 8B.

FIG. 10 is a flowchart of a photographing operation according to a second embodiment, which is performed by the image pickup apparatus.

FIG. 11A and FIG. 11B are diagrams that illustrate another example of the photographing scene.

FIG. 12A, FIG. 12B, and FIG. 12C are diagrams that illustrate a moving body prediction processing performed in S605 of FIG. 10.

FIG. 13 is a flowchart of the moving body prediction processing performed in S605 of FIG. 10.

FIG. 14 is a flowchart of an aperture and focal position adjustment processing performed in S607 of FIG. 10.

FIG. 15 is a diagram that illustrates a relationship between the F-number and the depth of field in the photographing scene that is shown in FIG. 11A and FIG. 11B.

### DESCRIPTION OF THE EMBODIMENTS

The present disclosure will now be described in detail below with reference to the accompanying drawings showing embodiments thereof.

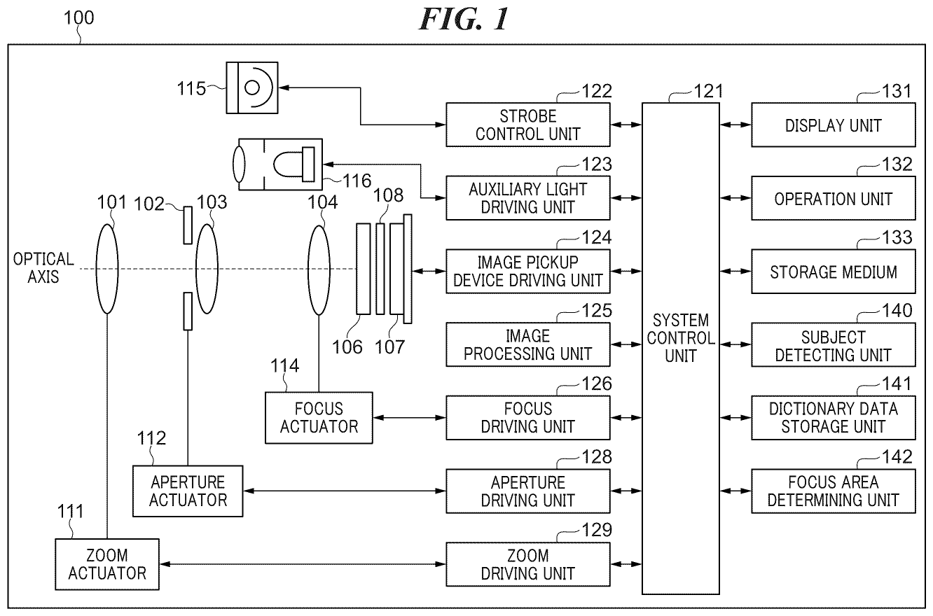

Hereinafter, embodiments of the present disclosure will be described in detail with reference to the accompanying drawings. FIG. 1 is a block diagram that illustrates a schematic configuration of an image pickup apparatus 100 according to an embodiment.

The image pickup apparatus 100 is a so-called digital still camera, and has a still image photographing function and a moving image photographing function. As shown in FIG. 1, the image pickup apparatus 100 includes an image pickup optical system, which includes a first lens group 101, an aperture 102, a second lens group 103, a third lens group 104, and an optical low-pass filter 106, as well as a zoom actuator 111, an aperture actuator 112, and a focus actuator 114.

The first lens group 101 is disposed in the image pickup optical system at a position closest to a subject (on the front side of the image pickup apparatus 100) so as to be movable along an image pickup optical axis. The aperture (a diaphragm) 102 adjusts an amount of light passing through the image pickup optical system by adjusting an aperture diameter. The second lens group 103 is disposed integrally with the aperture 102 so as to be movable in a direction of the image pickup optical axis (in an image pickup optical axis direction) by an actuator (not shown), and cooperates with the first lens group 101 to realize a variable magnification function (a zoom function). The third lens group 104 is a so-called focus lens, and performs a focus adjustment by moving in the image pickup optical axis direction. The optical low-pass filter 106 is an optical element for reducing false colors and moire in an image picked up (a picked-up image). The zoom actuator 111 is a driving means (a driving unit) that causes the first lens group 101 to move in the image pickup optical axis direction. The aperture actuator 112 drives the aperture 102 to adjust an aperture value (an F-number). The focus actuator 114 is a driving means (a driving unit) that causes the third lens group 104 to move in the image pickup optical axis direction.

The image pickup apparatus 100 includes an image pickup device (an image sensor) 107, a shutter 108, a system control unit 121, a strobe control unit 122, an auxiliary light driving unit 123, an image pickup device driving unit 124, an image processing unit 125, a focus driving unit 126, an aperture driving unit 128, and a zoom driving unit 129. In addition, the image pickup apparatus 100 includes a strobe device 115, an AF auxiliary light emitting unit 116, a display unit 131, an operation unit 132, a storage medium 133, a subject detecting unit 140, a dictionary data storage unit 141, and a focus area determining unit 142.

The image pickup device 107 is, for example, configured by a two-dimensional CMOS sensor and its peripheral circuits. An optical image that passes through the image pickup optical system and is formed on an image pickup surface of the image pickup device 107 is converted into analog electrical signals by the image pickup device 107, and the generated analog electrical signals are outputted to the system control unit 121 via the image pickup device driving unit 124. The system control unit 121 converts the analog electrical signals into digital image signals and supplies the digital image signals to the functional unit(s) that require the digital image signals. The shutter 108 controls an exposure time of the image pickup device 107 to incident light.

The system control unit 121 includes a central processing unit (a CPU), a read only memory (a ROM), a random access memory (a RAM), an A/D converter, a D/A converter, a communication interface circuit, etc., all of which are not shown in FIG. 1, and comprehensively controls the respective units of the image pickup apparatus 100 by loading a predetermined program that has been stored in the ROM into the RAM. It should be noted that some of functions of the system control unit 121 may be implemented as hardware circuits, and some of the circuits may use reconfigurable circuits such as field programmable gate arrays (FPGAs). In addition, in the present embodiment, the system control unit 121 performs a calculation for focus detection, which will be described below, but in order to shorten the calculation time, a configuration may be adopted in which a part of the calculation is performed by a dedicated hardware circuit.

The image pickup device driving unit 124 controls the operation of the image pickup device 107 in accordance with commands from the system control unit 121. It should be noted that an A/D conversion function for converting the analog electrical signals outputted from the image pickup device 107 into the digital image signals may be provided in the image pickup device driving unit 124 instead of in the system control unit 121. The image processing unit 125 obtains the digital image signals from the system control unit 121, and performs various types of image processing such as gamma conversion, color interpolation, and compression/expansion to generate image data.

The display unit 131 includes a liquid crystal display, an organic EL display, or the like, and displays various kinds of images and information such as information about an image pickup mode, a live view video image, a confirmation image after photographing, and an in-focus state during focus detection. The operation unit 132 includes a power button, a release button, a zoom operation button, a mode selection button, a menu button, and the like. It should be noted that when the release button is half-pressed, a switch SW1 (not shown) is turned on, and photographing preparation processes such as an automatic exposure process (an AE process) and an autofocus process (an AF process) are executed. Then, when the release button is fully pressed, a switch SW2 (not shown) is turned on, and a series of photographing operations from exposure of the image pickup device 107 to storing image data of a photographed image are executed.

The storage medium 133 is, for example, a memory card such as a flash memory that is attachable to and detachable from the image pickup apparatus 100, and stores and preserves the image data of the photographed image. The focus driving unit 126 drives the focus actuator 114 in response to a focus drive command from the system control unit 121 to cause the third lens group 104 to move in the image pickup optical axis direction. The aperture driving unit 128 drives the aperture actuator 112 in response to an aperture drive command from the system control unit 121 to adjust the aperture value of the aperture 102. The zoom driving unit 129 drives the zoom actuator 111 in response to a zoom operation performed by a photographer (a user) to cause the first lens group 101 to move in the image pickup optical axis direction.

The subject detecting unit 140 performs a subject detection processing and a characteristic region detection processing based on dictionary data for subject detection (subject detection dictionary data), which has been set by the photographer of the image pickup apparatus 100 in order to detect a specific subject. The subject detection dictionary data defines characteristics of subjects for each type of subject (for example, “person”, “automobile”, “animal”, etc.), and has been stored in the dictionary data storage unit 141. In the subject detection processing, the type of the subject is detected.

The photographer of the image pickup apparatus 100 is not limited to set one piece of subject detection dictionary data, but is able to set a plurality of pieces of subject detection dictionary data so as to be capable of detecting a plurality of types of subjects. In the case where the plurality of pieces of subject detection dictionary data have been set, the photographer of the image pickup apparatus 100 is able to set, via the operation unit 132, in what order the plurality of pieces of subject detection dictionary data, which have been set, are to be used to detect the subjects.

The subject detection dictionary data further defines an upper hierarchy corresponding to the entire area of the subject and a lower hierarchy corresponding to a partial area of the subject, and the number of lower hierarchies is not limited to one. For example, in “person (human)” that is one of the subject detection dictionary data, “whole body” is defined as the upper hierarchy, and a plurality of parts such as “upper body”, “face (or head)”, and “eye” are defined as the lower hierarchies. In addition, in “automobile” that is one of the subject detection dictionary data, “car body” is defined as the upper hierarchy, and “front grill”, “headlight”, “tire”, and the like are defined as the lower hierarchies.

The characteristic region detection processing is a processing that, in order to be used as an area to be focused on (a focus area), hierarchically detects characteristic parts of a detected subject, and specifically, in the characteristic region detection processing, the respective parts of the upper hierarchy and the lower hierarchies that have been defined in the subject detection dictionary data are detected as characteristic regions. It should be noted that the characteristic region is detected as a rectangular region that includes a characteristic part of the subject, and is preferably detected as a rectangular region with a minimum area.

It should be noted that the detection of the type of the subject and the detection of the characteristic region may be performed by first detecting a part of the upper hierarchy and then detecting parts of the lower hierarchies from the region of the upper hierarchy that has been detected, or vice versa. For example, in the case of detecting a person (in the case where the subject detection dictionary data of “person” has been set), it is easy to detect “face” which is the lower hierarchy. Therefore, after “face” has been detected, the whole person may be detected (estimated) from the position of “face”, and at the same time, “eye”, “mouth”, etc. may be detected from within the region of “face”.

The focus area determining unit 142 determines one focus area for each subject from among the characteristic regions that have been detected by the characteristic region detection processing that is performed for each subject that has been detected in the subject detection processing.

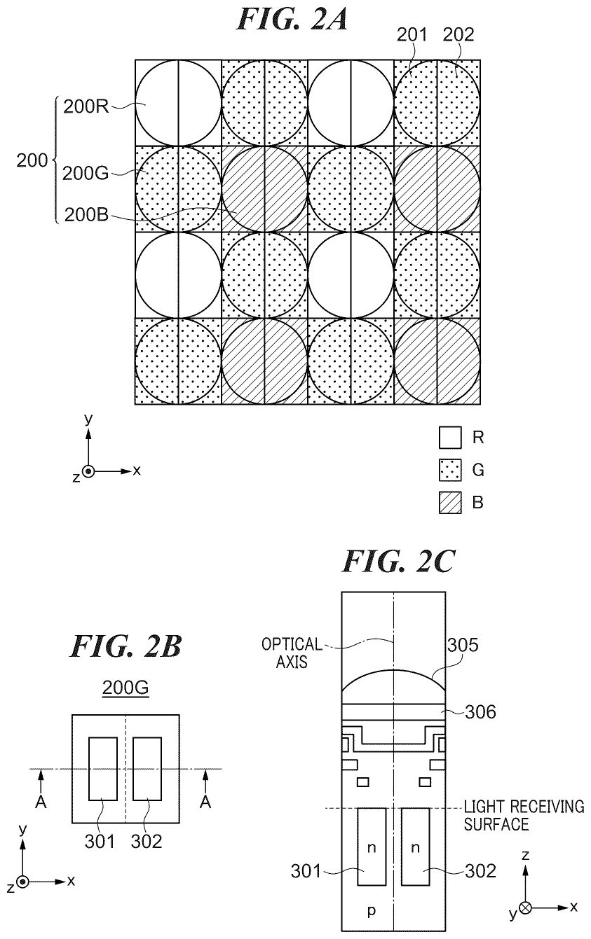

Next, a pixel configuration of the image pickup device 107 will be described. FIG. 2A is a plan view that illustrates a pixel array (a pixel arrangement) of the image pickup device 107. A z axis shown in FIG. 2A is parallel to the image pickup optical axis (see FIG. 1). The image pickup device 107 has a substantially rectangular image pickup surface on which a large number of 2-column by 2-row pixel groups 200 have been arranged respectively in an x direction and a y direction that are perpendicular to each other and are also perpendicular to the z axis, and each pixel outputs an image pickup signal. It should be noted that FIG. 2A only shows a range of 4-column by 4-row. FIG. 2B is a plan view of a pixel 200G shown in FIG. 2A. FIG. 2C is a sectional view taken along arrows A-A shown in FIG. 2B.

As shown in FIG. 2A, a 2-column by 2-row pixel group 200 includes one pixel 200R having a spectral sensitivity of R (red), two pixels 200G having a spectral sensitivity of G (green), and one pixel 200B having a spectral sensitivity of B (blue), which are arranged in a Bayer array. Each of the pixels 200R, 200G, and 200B has two focus detection pixels 201 and 202 arranged in 2 columns and 1 row.

In the present embodiment, the pixel composed of the two focus detection pixels arranged in the x direction is taken up, but the present disclosure is not limited to this, and the two focus detection pixels may be arranged in the y direction, and the number of focus detection pixels in one pixel is not limited to two. The image pickup device 107 may have a configuration in which pixels that each has a plurality of focus detection pixels and pixels for image generation (image generation pixels) that each has one pixel are combined.

Since the pixels 200G, 200B, and 200R have the same configuration except for the spectral characteristics, in the following description, the configuration of the pixel 200G will be described in detail as an example, and descriptions of the pixels 200B and 200R will be omitted.

As shown in FIG. 2C, a microlens 305 for collecting incident light is provided on the side of a light receiving surface of a semiconductor substrate such as a silicon substrate on which photodiodes (PDs) of the pixel 200G are formed. One microlens 305 is arranged for each pixel at a position spaced a predetermined distance from the light receiving surface in the z-direction. In addition, in one pixel 200G, two PDs (that is, photoelectric conversion units 301 and 302), which are divided into two in the x direction, are formed. The two photoelectric conversion units 301 and 302 correspond to the focus detection pixels 201 and 202 shown in FIG. 2A, respectively. It should be noted that in the case where each pixel is divided into Nx in the x direction and is divided into Ny in the y direction, the number of photoelectric conversion units to be formed is Nx×Ny=NLF (the number of divisions).

Each of the photoelectric conversion units 301 and 302 is formed as a pn junction PD made up of a p-type layer and an n-type layer. It should be noted that each of the photoelectric conversion units 301 and 302 may be configured as a PD with a pin structure in which an intrinsic layer is provided between a p-type layer and an n-type layer, as necessary.

In the pixel 200G, a color filter 306 is provided between the microlens 305, and the photoelectric conversion units 301 and 302. If necessary, the spectral transmittance of the color filter 306 may be changed for each pixel or each photoelectric conversion unit, and it is also possible to adopt a configuration in which no color filter is provided.

The light incident on the pixel 200G is collected by the microlens 305, dispersed by the color filter 306, and then incident on the photoelectric conversion units 301 and 302. In the photoelectric conversion units 301 and 302, pairs of electrons and holes are generated in accordance with the amount of the incident light (the amount of received light), and after they are separated in a depletion layer, the electrons (negative charges) are accumulated in the n-type layer. On the other hand, the holes (positive charges) are discharged to the outside of the image pickup device 107 through the p-type layer connected to a constant voltage source (not shown). The electrons accumulated in the n-type layers of the photoelectric conversion units 301 and 302 are transferred to an electrostatic capacity unit (FD) via a transfer gate, where they are converted into a voltage signal.

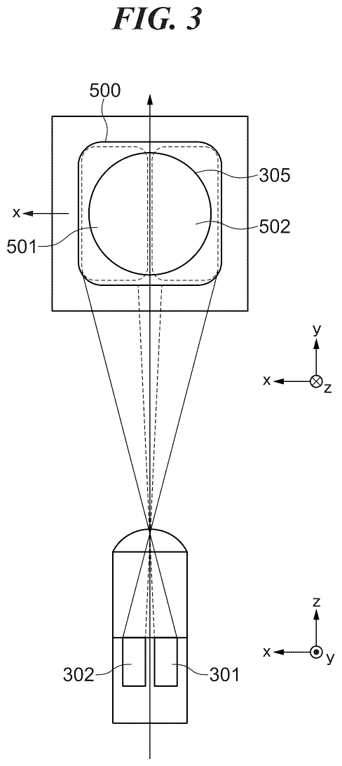

FIG. 3 is a sectional view of the arrows A-A cross section of the pixel 200G, which is shown in FIG. 2B, when viewed from the +y side, and a view that shows a pupil plane at a position spaced a predetermined distance from the image pickup surface of the image pickup device 107 in the z-direction. It should be noted that in FIG. 3, in order to correspond to the coordinate axes of the exit pupil plane, the x axis and the y axis of the sectional view are inverted with respect to FIG. 2A, FIG. 2B, and FIG. 2C.

The image pickup surface of the image pickup device 107 is disposed on an image forming surface of the image pickup optical system. In other words, the incident light forms an image on the image pickup surface. Two pupil division regions that constitute a pupil region 500 that is capable of receiving light by the entire pixel 200G when the photoelectric conversion units 301 and 302 are combined are referred to as a first pupil division region 501 and a second pupil division region 502, respectively. The first pupil division region 501 and the light receiving surface of the photoelectric conversion unit 301 whose centroid position is decentered in the −x direction are in a substantially conjugate relationship via the microlens 305. Therefore, the first pupil division region 501 corresponds to a pupil region that is capable of receiving light by the focus detection pixel 201, and the centroid position of the first pupil division region 501 is decentered to the +x side on the pupil plane. Similarly, the second pupil division region 502 and the light receiving surface of the photoelectric conversion unit 302 whose centroid position is decentered in the +x direction are in a substantially conjugate relationship via the microlens 305. Therefore, the second pupil division region 502 corresponds to a pupil region that is capable of receiving light by the focus detection pixel 202, and the centroid of the second pupil division region 502 is decentered to the −x side on the pupil plane.

Therefore, phase difference information is obtained by performing a correlation calculation on output signals of the focus detection pixels 201 and 202, and the obtained phase difference information is converted into a defocus amount (an out-of-focus amount) by using a publicly known technique, thereby enabling image pickup surface phase difference AF to be performed to detect a focal position.

It should be noted that the image pickup signals outputted from the image pickup device 107 are not only used as focus detection signals for performing the image pickup surface phase difference AF, but are also used to generate a picked-up image and a photographed image. It should be noted that although FIGS. 2A, 2B, 2C, and 3 show a configuration in which one pixel is pupil-divided into two in the x direction, the number of pupil divisions and the pupil division direction are not limited to those. For example, the pupil division direction may be only the y direction, or the pupil may be divided in both the x direction and the y direction (2×2=4 pupil divisions).

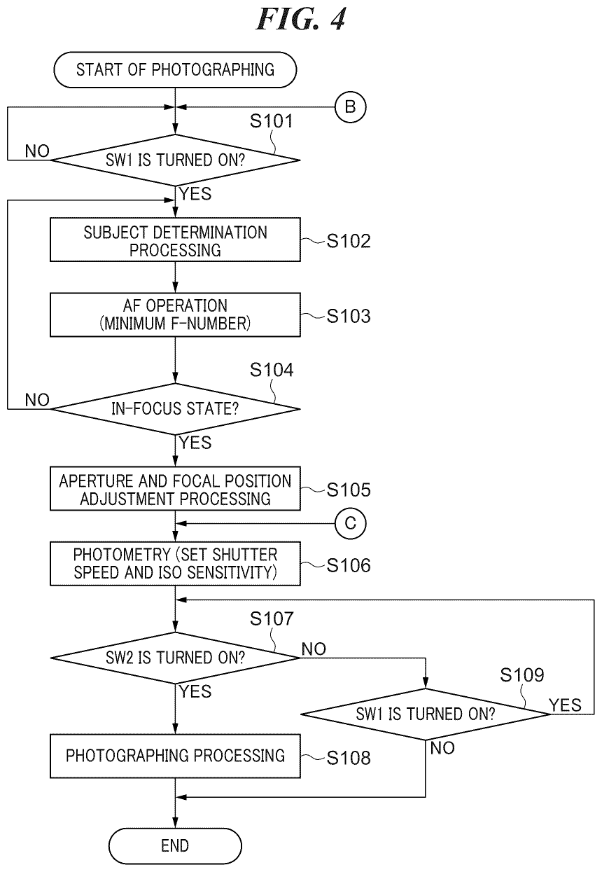

Hereinafter, a first embodiment will be described. FIG. 4 is a flowchart of a photographing operation according to the first embodiment, which is performed by the image pickup apparatus 100. Respective processes (respective steps) indicated by S numbers in the flowchart of FIG. 4 are realized by the CPU included in the system control unit 121 loading a predetermined program that has been stored in the ROM into the RAM and comprehensively controlling the operations of the respective units of the image pickup apparatus 100. When a power switch (the power button) of the image pickup apparatus 100 is turned on by the photographer, an image pickup operation performed by the image pickup device 107 is started, a live view video image is displayed on the display unit 131, and the process of S101 is started.

In S101, the system control unit 121 determines whether or not the switch SW1 is turned on (whether or not the release button is half-pressed). In the case where the system control unit 121 determines that the switch SW1 is not turned on (NO in S101), the system control unit 121 continues to execute the process of S101, and on the other hand, in the case where the system control unit 121 determines that the switch SW1 is turned on (YES in S101), the system control unit 121 executes the process of S102.

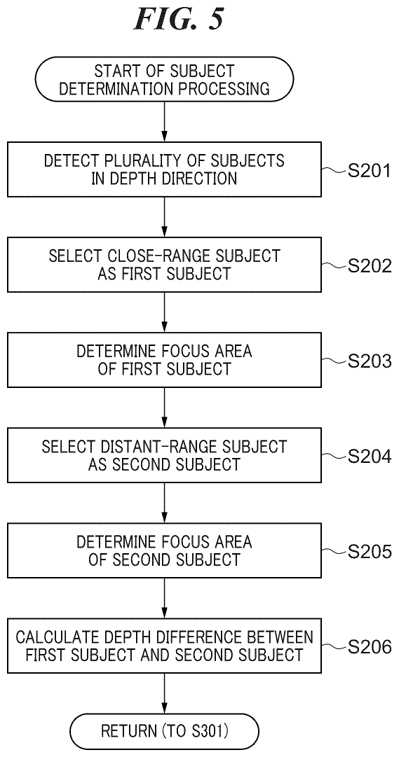

In S102, the system control unit 121 performs a subject determination processing that detects subjects from the live view video image (a frame image) by means of the subject detecting unit 140 and determines a subject to be focused on. Here, the subject determination processing performed in S102 will be described in detail with reference to FIG. 5.

FIG. 5 is a flowchart of the subject determination processing performed in S102 of FIG. 4. As shown in FIG. 5, in S201, the system control unit 121 causes the subject detecting unit 140 to perform the subject detection processing that detects subjects from the frame image. The subject detecting unit 140 uses the subject detection dictionary data, which has been set, to detect, from the frame image, subjects that match the characteristics specified (defined) in the subject detection dictionary data.

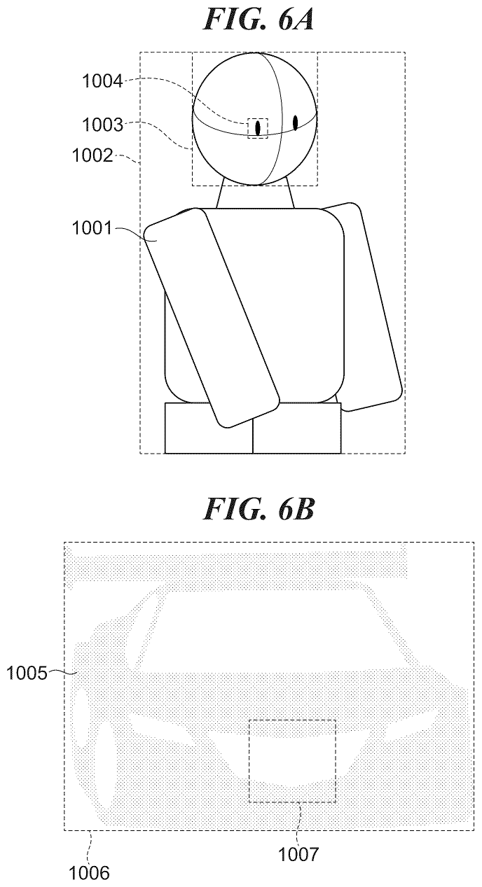

The subject detecting unit 140 further performs the characteristic region detection processing that has been described above. FIG. 6A and FIG. 6B are schematic diagrams that illustrate a hierarchical detection of characteristic regions, which is performed in S201 of FIG. 5. FIG. 6A shows a case where the subject is a person, and FIG. 6B shows a case where the subject is an automobile (a car). FIG. 6A schematically shows that a person 1001 is detected as the subject, a characteristic region 1002 corresponding to “whole body”, which has been detected as the upper hierarchy of the person 1001, is detected, and characteristic regions 1003 and 1004 corresponding to “face” and “eye”, which have been detected as the lower hierarchies of the person 1001, are detected. FIG. 6B schematically shows that a car 1005 is detected as the subject, a characteristic region 1006 corresponding to “car body”, which has been detected as the upper hierarchy of the car 1005, is detected, and a characteristic region 1007 corresponding to “front grill (front end portion of car body)”, which has been detected as the lower hierarchy of the car 1005, is detected. It should be noted that in the case where a person is captured from behind, “head” and the like may be detected as the lower hierarchies, and in the case where an automobile (a car) is captured from the side, “side window”, “tire”, and the like may be detected as the lower hierarchies.

Since the present disclosure relates to setting of photographing parameters in the case where a plurality of subjects have been detected in a depth direction from the image pickup apparatus 100 toward the subjects (in a depth-of-field direction), the following description will be given on the assumption that a plurality of subjects have been detected in the depth direction. It should be noted that in the case where a plurality of subjects have not been detected in the depth direction, but only one subject has been detected in the depth direction, the photographer just sets a desired aperture value and performs photographing.

In S202, the system control unit 121 selects as a first subject, from among a plurality of subjects that have been detected in S201, a closest-range subject (a subject closest to the image pickup apparatus 100), a subject located at a center of the image, or a subject with the largest area in the image. It should be noted that for example, in the case where a plurality of persons have been detected, which person is to be the first subject may be automatically determined based on a preset setting, or may be determined by selection performed by the photographer at the time of subject detection. For convenience of description, here, it is assumed that a close-range subject has been selected as the first subject. The subject detecting unit 140 may have a function for selecting the first subject, and a second subject that will be described below.

In S203, the system control unit 121 causes the focus area determining unit 142 to determine one area to be focused on (a focus area) from among characteristic regions that have been hierarchically detected for the first subject. In the case of FIG. 6A, one of the characteristic regions 1002, 1003, and 1004 is determined as the focus area, and in the case of FIG. 6B, one of the characteristic regions 1006 and 1007 is determined as the focus area. The determined focus area is displayed superimposed on the live view video image being displayed on the display unit 131.

It should be noted that in the case where a plurality of characteristic regions have been detected, any one of the plurality of characteristic regions may be selected as the focus area, but rules may be determined in advance, such as prioritizing characteristic regions of the lower hierarchies regardless of the type of the subject.

In S204, the system control unit 121 selects as the second subject, from among the plurality of subjects that have been detected in S201, a subject that exists farther away than the first subject (a distant-range subject). Inevitably, the positional relationship between the first subject and the second subject relatively becomes a relationship between the close-range subject and the distant-range subject. It should be noted that even in the case where the subject located at the center of the image or the subject with the largest area on the image plane (in the image) has been selected as the first subject in S202, the second subject needs to be a subject that is farther away in the depth direction than the first subject. In other words, the first subject is selected on the assumption that the second subject is located farther away.

In S205, the system control unit 121 causes the focus area determining unit 142 to determine a focus area from among characteristic regions that have been hierarchically detected for the second subject. It should be noted that the process of S205 is performed in the same manner as the process of S203, and therefore the description thereof will be omitted here.

In S206, the system control unit 121 calculates a depth difference between the first subject and the second subject (a distance in the depth direction between the first subject and the second subject), and ends the subject determination processing. The method for calculating the depth difference between the first subject and the second subject may be a publicly known technique. As a result, the processing proceeds from S102 to S103 in the flowchart of FIG. 4.

Returning to the description of the flowchart of FIG. 4. In S103, the system control unit 121 controls the focus driving unit 126 and the aperture driving unit 128 to execute an AF operation with respect to the first subject by using the focus area that has been determined in S203 with the aperture 102 opened to its maximum (set to its minimum F-number).

In S104, the system control unit 121 determines whether or not an in-focus state has been obtained with respect to the first subject by the AF operation executed in S103. Specifically, the system control unit 121 calculates a defocus amount based on the respective output signals of the focus detection pixels 201 and 202 (the photoelectric conversion units 301 and 302), and in the case where the calculated defocus amount is within a range of a preset value, determines that the in-focus state has been obtained. In the case where the system control unit 121 determines that the in-focus state has not been obtained with respect to the first subject (NO in S104), the system control unit 121 executes the process of S102, and on the other hand, in the case where the system control unit 121 determines that the in-focus state has been obtained with respect to the first subject (YES in S104), the system control unit 121 executes the process of S105.

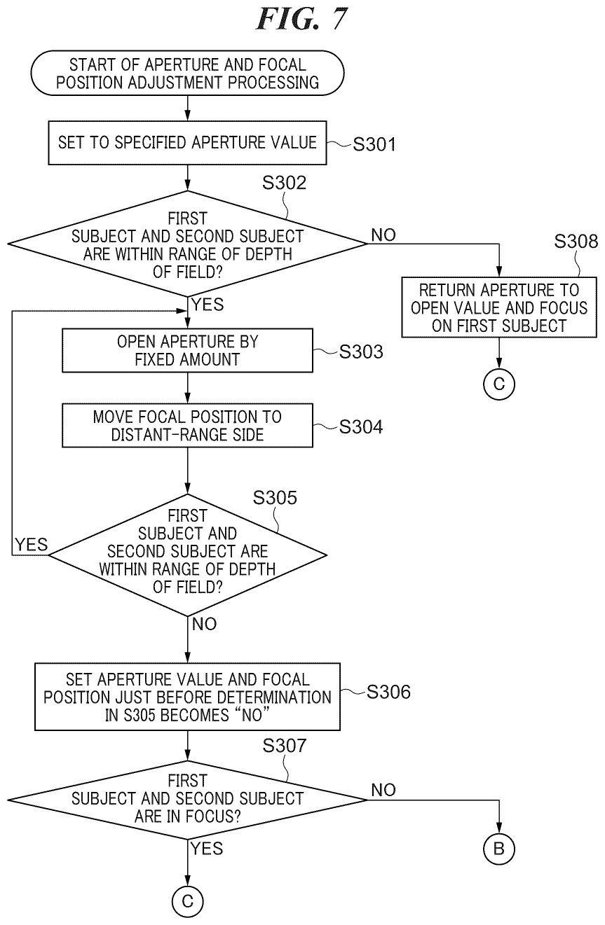

In S105, the system control unit 121 adjusts the aperture and the focal position by using the previously calculated defocus amount, thereby setting an appropriate depth of field. Here, the process of S105 will be described with reference to FIG. 7. FIG. 7 is a flowchart of an aperture and focal position adjustment processing performed in S105 of FIG. 4.

In S103, the aperture 102 is open (the F-number is set to the minimum value), so in S301, the system control unit 121 narrows the aperture 102 to a specified F-number (a specified aperture value) that has been set in advance (increases the F-number). It should be noted that “the specified aperture value” is set in accordance with the configuration of the image pickup optical system, and is capable of becoming, for example, the upper limit value of a range of F-numbers desired by the photographer, and is capable of being set by the photographer via the operation unit 132.

In S302, the system control unit 121 determines whether or not the first subject and the second subject are within a range of the depth of field. In the case where the system control unit 121 determines that the first subject and the second subject are within the range of the depth of field (YES in S302), the system control unit 121 executes the process of S303.

In S303, the system control unit 121 performs an operation that opens the aperture 102 by a fixed amount (reduces the F-number by a fixed value). In S304, the system control unit 121 performs an operation that causes the focal position to move to a distant-range side (the side of the second subject). In S305, the system control unit 121 determines whether or not the first subject and the second subject are within the range of the depth of field. In other words, in S303 to S305, it is determined whether or not the state, in which the first subject and the second subject are within the range of the depth of field, has been maintained when the focal position is shifted toward the side of the second subject while the aperture 102 is gradually driven toward an open side. In the case where the system control unit 121 determines that the first subject and the second subject are within the range of the depth of field (YES in S305), the system control unit 121 executes the process of S303, and on the other hand, in the case where the system control unit 121 determines that the first subject and the second subject are not within the range of the depth of field (NO in S305), the system control unit 121 executes the process of S306.

In S306, the system control unit 121 sets, in photographing conditions, the aperture value and the focal position at the determination result of “YES” immediately before the determination result of S305 becomes the determination result of “NO”. In the case of having become the aperture value and the focal position at which the first subject and the second subject are no longer within the range of the depth of field, by returning to the previous aperture value and the previous focal position, it is possible to determine the minimum F-number at which the first subject and the second subject are within the range of the depth of field.

In S307, the system control unit 121 confirms (determines) whether or not the first subject and the second subject are in focus. For example, if there is no change in the positional relationship between the subject and the photographer, since the first subject and the second subject should be within the range of the depth of field in S306, the determination result of S307 becomes “YES”. On the other hand, for example, in the case where the first subject or the second subject moves, there is no guarantee that the first subject or the second subject will be within the range of the depth of field when the process of S306 is performed. In the case where the system control unit 121 determines that the first subject and the second subject are in focus (YES in S307), the system control unit 121 ends the aperture and focal position adjustment processing shown in the flowchart of FIG. 7 and executes the process of S106. On the other hand, in the case where the system control unit 121 determines that the first subject or the second subject is not in focus (NO in S307), the system control unit 121 ends the aperture and focal position adjustment processing shown in the flowchart of FIG. 7 and executes the process of S101.

In the case where the system control unit 121 determines in the previous S302 that the first subject and the second subject are not within the range of the depth of field (NO in S302), the system control unit 121 executes the process of S308.

In S308, the system control unit 121 returns the aperture 102 to an open aperture value (an open value) that is the aperture value before the process of S301, refocuses on the first subject, and then executes the process of S106. It should be noted that in the case where the determination result of S302 becomes “NO”, when the specified aperture value that has been set in S301 is not the maximum value, that is, when the aperture 102 is capable of being further narrowed, the F-number may first be changed to the maximum value, and then the process of S302 may be executed again. This method is capable of being used in the case where the photographer does not impose any restrictions on the F-number during photographing. As a result, in the case where the re-determination result of S302 becomes “NO”, the process of S308 may be executed, and on the other hand, in the case where the re-determination result of S302 becomes “YES”, the process of S303 may be executed.

In addition, in the process of S105, it is possible to determine the minimum F-number at which the first subject and the second subject are within the range of the depth of field by not narrowing the aperture 102 in S301, but gradually narrowing the aperture 102 from the fully open state while shifting the focal position toward the side of the second subject. However, it is easier to control determining the minimum F-number at which the first subject and the second subject are within the range of the depth of field from the state in which the aperture 102 has been narrowed.

Returning to the description of the flowchart of FIG. 4. In S106, the system control unit 121 sets a shutter speed Tv and an ISO sensitivity that provide a proper exposure with the aperture value that has been set in S105.

In S107, the system control unit 121 determines whether or not the switch SW2 is turned on (whether or not the release button is fully pressed). In the case where the system control unit 121 determines that the switch SW2 is turned on (YES in S107), the system control unit 121 executes the process of S108, and on the other hand, in the case where the system control unit 121 determines that the switch SW2 is not turned on (NO in S107), the system control unit 121 executes the process of S109.

In S108, the system control unit 121 performs a photographing processing (a series of processes from exposure of the image pickup device 107 to storing image data), and then ends the processing according to the flowchart of FIG. 4.

In S109, the system control unit 121 determines whether or not the switch SW1 is turned on (whether or not the release button is half-pressed). In the case where the system control unit 121 determines that the switch SW1 is not turned on (NO in S109), the system control unit 121 ends the processing according to the flowchart of FIG. 4, and on the other hand, in the case where the system control unit 121 determines that the switch SW1 is turned on (YES in S109), the system control unit 121 executes the process of S107.

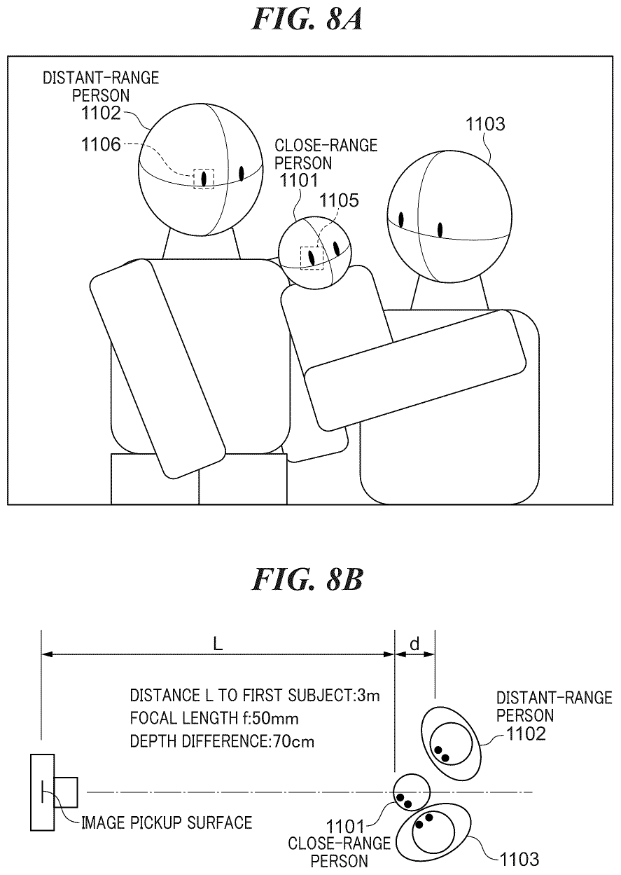

FIG. 8A is a diagram that illustrates an example of a photographing scene in the first embodiment, and FIG. 8B shows the positional relationship between the image pickup apparatus 100 and subjects in the photographing scene of FIG. 8A. In the photographing scene of FIG. 8A, three persons have been detected by the subject detecting unit 140, a closest-range person 1101 has been selected as the first subject by the system control unit 121 or the photographer, and a most-distant-range person 1102 has been selected as the second subject by the system control unit 121 or the photographer. The focus area determining unit 142 determines a focus area from among characteristic regions that have been hierarchically detected with respect to the person 1101 that is the first subject and the person 1102 that is the second subject. Here, since the pupil (eye) of the person 1101 and the pupil (eye) of the person 1102 have been detected, it is possible to focus on “pupil (eye)”, which is the lower hierarchy, with respect to the first subject and the second subject. In this case, the AF operation in S103 is performed with respect to a characteristic region 1105 of the first subject (the person 1101). Then, in S302 and S305, it is determined whether or not the characteristic region 1105 of the person 1101 and a characteristic region 1106 of the person 1102 are within the range of the depth of field.

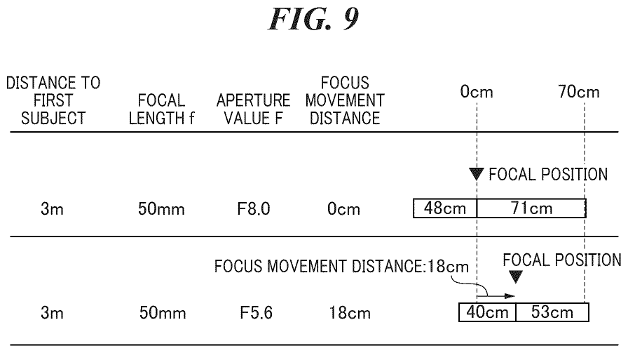

FIG. 9 is a diagram for explaining a relationship between the F-number, the focal position, and the depth of field in the photographing scene that is shown in FIG. 8A and FIG. 8B. A front depth of field Lf and a rear depth of field Lr are respectively expressed by the following Expression 1 and Expression 2 by using a distance L from the image pickup surface to the first subject, a focal length f of the image pickup optical system, a permissible circle of confusion δ, and an aperture value F. Since the in-focus range is from a range of “L−Lf” to a range of “L+Lr”, a range of the depth of field (a depth-of-field range) ΔL is expressed by the following Expression 3.

$${L}_{f} = \frac{δ {LF}^{2}}{{f}^{2} + δ FL} \qquad [ Expression 1 ]$$

$${L}_{r} = \frac{δ {LF}^{2}}{{f}^{2} - δ FL} \qquad [ Expression 2 ]$$

$$Δ L = {L}_{f} + {L}_{r} \qquad [ Expression 3 ]$$

In FIG. 9, the pupil (the focus area) of the first subject, that is, the eye (the focus area) of the first subject is located at “0 cm”, and the pupil of the second subject, that is, the eye of the second subject is located at “70 cm”. When focusing on the eye of the first subject, in the case where the focal length f of the image pickup optical system is 50 mm (f=50 mm), the distance L from the image pickup surface of the image pickup device 107 to the eye of the first subject is 3 m (L=3 m), and the aperture value F is 8 (F=8), the rear depth of field Lr will be approximately 71 cm. It should be noted that the permissible circle of confusion 8 is a value that has been determined in advance according to the size of the image pickup device 107. Therefore, in this state, it is possible to achieve a state in which the eye of the first subject and the eye of the second subject are in focus only within the range of the rear depth of field Lr.

In the case where the aperture value Fis 5.6 (F=5.6), since the rear depth of field Lr is approximately 53 cm, it is not possible to achieve the state in which the eye of the first subject and the eye of the second subject are in focus only within the range of the rear depth of field Lr. Therefore, the front depth of field Lf of about 40 cm (Lf=about 40 cm) is utilized. For example, by causing the focal position to move 18 cm toward the distant-range side, even in the case where the aperture value F is 5.6 (F=5.6), it is possible to achieve the state in which the eye of the first subject and the eye of the second subject are in focus.

As described above, in the photographing operation according to the first embodiment, in the case where a plurality of subjects at different positions in the depth direction have been detected, the plurality of subjects that have been detected are kept within the range of the depth of field in a state, in which the aperture is opened as wide as possible, and then are photographed. In this case, the detection of hierarchical characteristic regions is performed for each of the plurality of subjects, and a focus area is determined from among the detected hierarchical characteristic regions. As a result, it is possible to obtain a high-quality image that has been focused on a part desired by the photographer and has an appropriate out-of-focus effect.

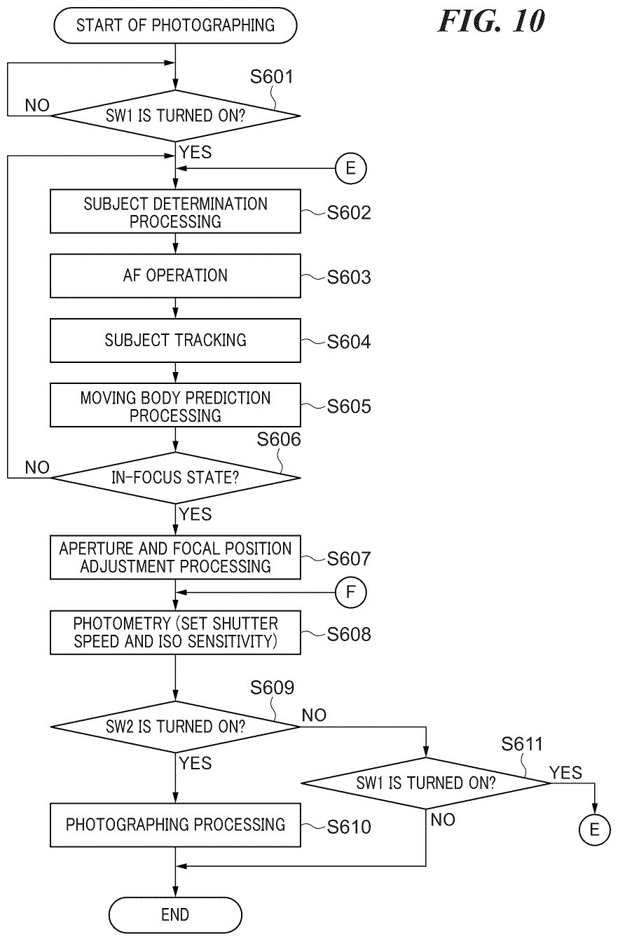

Hereinafter, a second embodiment will be described. In the first embodiment, the subject with little movement has been taken up, but in the second embodiment, a case where the subject is a moving body will be described. FIG. 10 is a flowchart of a photographing operation according to the second embodiment, which is performed by the image pickup apparatus 100. Respective processes (respective steps) indicated by S numbers in the flowchart of FIG. 10 are realized by the CPU included in the system control unit 121 loading a predetermined program that has been stored in the ROM into the RAM and comprehensively controlling the operations of the respective units of the image pickup apparatus 100. After turning on the power switch of the image pickup apparatus 100, the photographer sets a still image photographing mode and also sets an AF mode to servo AF (subject tracking AF). After these settings are made, an image pickup operation performed by the image pickup device 107 is started, a live view video image is displayed on the display unit 131, and the process of S601 is started.

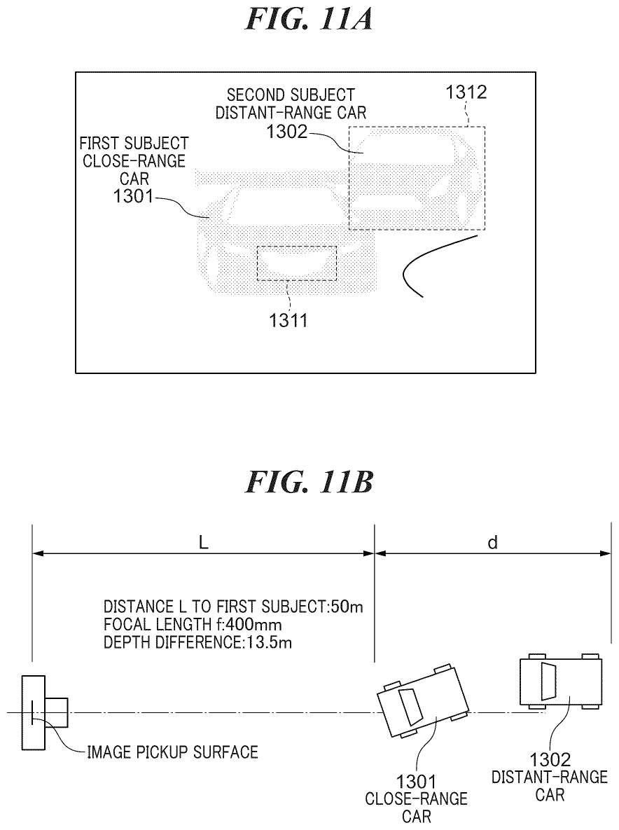

The processes of S601 to S603 are the same as the processes of S101 to S103 in the first embodiment, and therefore the descriptions thereof will be omitted. FIG. 11A is a diagram that illustrates an example of a photographing scene in the second embodiment, and FIG. 11B shows the positional relationship between the image pickup apparatus 100 and subjects in the photographing scene of FIG. 11A. In the photographing scene of FIG. 11A, in a subject determination processing performed in S602, two cars 1301 and 1302 have been detected by the subject detecting unit 140, the close-range car 1301 has been selected as a first subject by the system control unit 121, and the distant-range car 1302 has been selected as a second subject by the system control unit 121. Here, it is assumed that the focus area determining unit 142 has determined a characteristic region 1311, which is the front end portion and is a lower hierarchy with respect to the close-range car 1301, as a focus area. On the other hand, since the front end portion of the distant-range car 1302 is not capable of being detected at all times because the front end portion of the distant-range car 1302 is obscured by the car 1301, it is assumed that the focus area determining unit 142 has determined a characteristic region 1312, which is the entire area, as a focus area.

In S604, the system control unit 121 starts subject tracking with the servo AF. The subject tracking referred to here is performed by a publicly known template matching process that uses the focus areas that have been set in S602 as templates, specifically, a process of searching for image areas similar to the templates from successively obtained frame images.

In S605, the system control unit 121 performs a moving body prediction calculation that predicts the position of the subject (a subject position) in the depth direction after a predetermined period of time has elapsed based on a subject image plane position obtained in the previous S603 (by the past focus detection) and a defocus amount obtained by the most recent focus detection, and performs focus control based on the calculation result of the moving body prediction calculation. Here, the process of S605 (a moving body prediction processing performed in S605) will be described in detail.

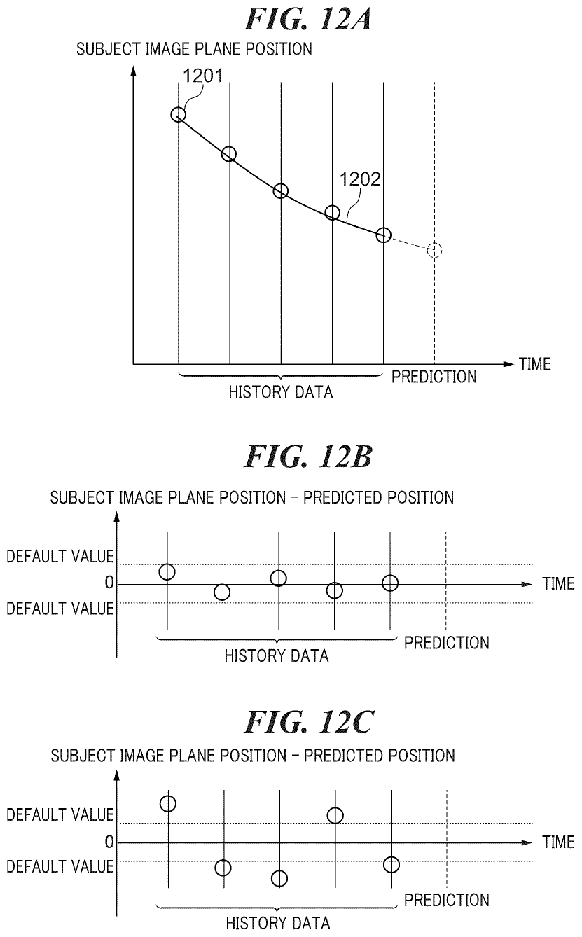

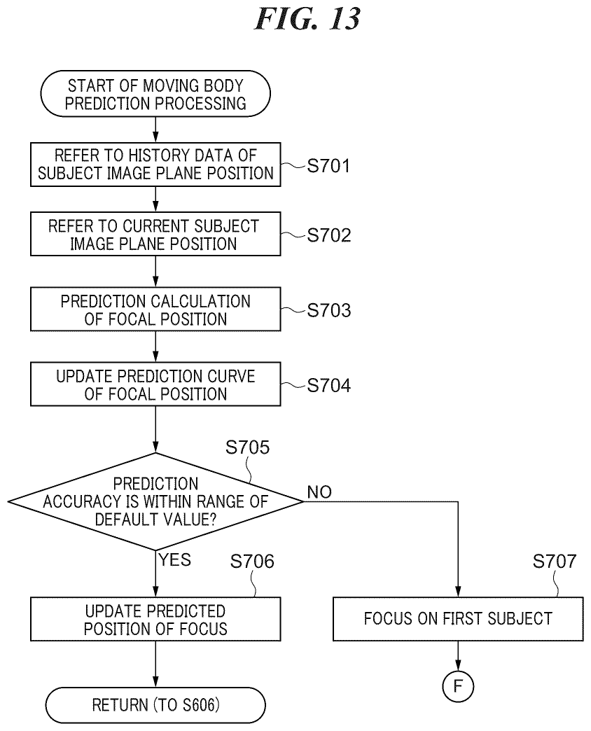

FIG. 12A, FIG. 12B, and FIG. 12C are diagrams that illustrate the moving body prediction processing performed in S605 of FIG. 10. FIG. 13 is a flowchart of the moving body prediction processing performed in S605 of FIG. 10. As shown in FIG. 13, in S701, the system control unit 121 refers to history data of respective subject image plane positions of the first subject and the second subject. Here, the subject image plane position refers to a position of the focal point in the case where the image pickup optical system (the lens groups) is located at a position where the subject is in focus. FIG. 12A shows the history data of the subject image plane position of the subject. It should be noted that the description with reference to FIG. 12A, FIG. 12B, and FIG. 12C will be given in a general manner and does not limit the subject to the first subject or the second subject. In FIG. 12A, the history data of the subject image plane position of the subject represents the transition of a subject image plane position 1201 at each predetermined time obtained in the past.

In S702, the system control unit 121 refers to the current subject image plane positions of the first subject and the second subject. In S703, the system control unit 121 predicts respective focal positions of the first subject and the second subject after a predetermined time based on the history data. In S704, the system control unit 121 updates prediction curves of the respective focal positions of the first subject and the second subject. FIG. 12A shows a prediction curve 1202 of the focal position based on the history data of the subject image plane position 1201.

A function prepared in advance is used for the prediction curve 1202. For example, a quadratic function f (t) expressed by the following Expression 4, in which a time t is a variable, is capable of being used. In updating the prediction curve performed in S704, values of respective coefficients a, b, and c of the quadratic function f(t) are updated.

$$f ( t ) = {at}^{2} + bt + c \qquad [ Expression 4 ]$$

In S705, the system control unit 121 determines whether or not the prediction accuracy is within a predetermined range of specified values. The prediction accuracy is a value indicating the degree of agreement between the focal position and the prediction curve, and a value such as a coefficient of determination (a publicly known technique) or a mean squared error (a publicly known technique) is capable of being used as the prediction accuracy. FIG. 12B is a diagram that illustrates the history data in the case where the prediction accuracy is high, and FIG. 12C is a diagram that illustrates the history data in the case where the prediction accuracy is low.

In the case where the system control unit 121 determines that the prediction accuracy is within the range of the specified values (for example, the relationship shown in FIG. 12B) (YES in S705), the system control unit 121 executes the process of S706. In S706, the system control unit 121 updates predicted positions of the respective focal positions of the first subject and the second subject, ends the moving body prediction processing shown in the flowchart of FIG. 13, and then advances the processing to S606.

In the determination process of S705, in the case where the system control unit 121 determines that the prediction accuracy is not within the range of the specified values (for example, the relationship shown in FIG. 12C) (NO in S705), the system control unit 121 executes the process of S707. In S707, the system control unit 121 focuses on the first subject, ends the moving body prediction processing shown in the flowchart of FIG. 13, and then advances the processing to S608.

Returning to the description of the flowchart of FIG. 10. In S606, the system control unit 121 determines whether or not an in-focus state has been obtained with respect to the first subject. In the case where the system control unit 121 determines that the in-focus state has been obtained with respect to the first subject (YES in S606), the system control unit 121 executes the process of S607, and on the other hand, in the case where the system control unit 121 determines that the in-focus state has not been obtained with respect to the first subject (NO in S606), the system control unit 121 executes the process of S602.

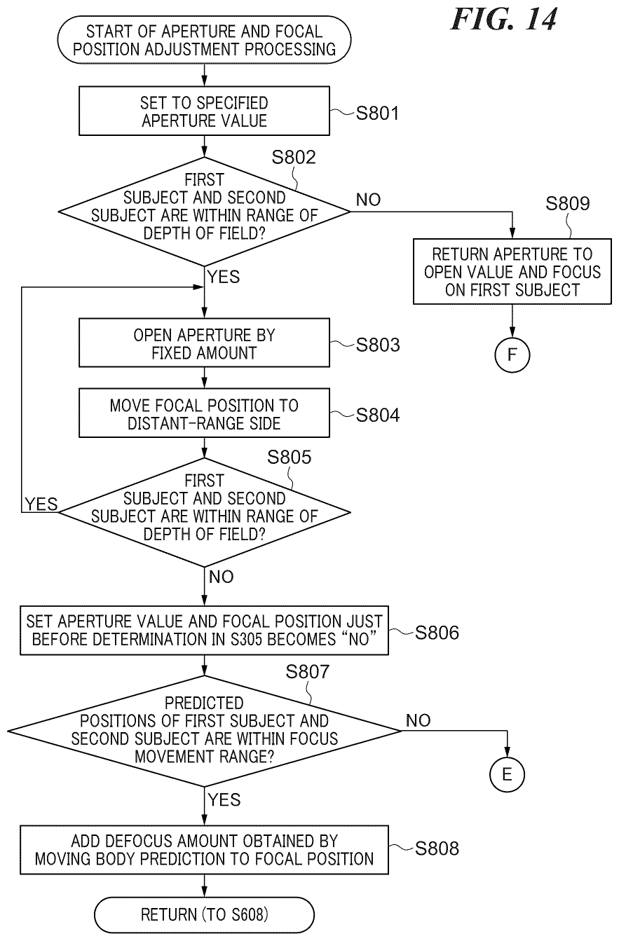

In S607, the system control unit 121 performs a processing for adjusting the aperture 102 and the focal position (an aperture and focal position adjustment processing). FIG. 14 is a flowchart of the aperture and focal position adjustment processing performed in S607 of FIG. 10. The processes of S801 to S806 are the same as the processes of S301 to S306 in the flowchart of FIG. 7, which have been described in the first embodiment, and therefore the descriptions thereof will be omitted here.

In S807, the system control unit 121 determines whether or not the predicted positions of the first subject and the second subject are within a focus movement range of the image pickup optical system (are within a range from the shortest photographing distance to infinity). As a result, it is possible to confirm whether or not it has not become a state in which the first subject and the second subject is not capable of being brought into focus. In the case where the system control unit 121 determines that the predicted positions of the first subject and the second subject are within the focus movement range (YES in S807), the system control unit 121 executes the process of S808, and on the other hand, in the case where the system control unit 121 determines that the predicted positions of the first subject and the second subject are not within the focus movement range (NO in S807), the system control unit 121 executes the process of S602.

In S808, the system control unit 121 performs a control to add the defocus amount that has been obtained by the moving body prediction to the focal position that has been set in S806, obtains a focal position to be used for photographing, ends the aperture and focal position adjustment processing shown in the flowchart of FIG. 14, and then executes the process of S608. It should be noted that “the defocus amount that has been obtained by the moving body prediction” is a difference between a focus position at a time point t, and a focus position at a time point t+Δt when a time Δt has elapsed since the time point t. In the case of explaining this with reference to FIG. 12A, it will be expressed as a difference between a focal position at a “prediction” time point and the latest subject image plane position in the history data.

Returning to the description of the flowchart of FIG. 10. The processes of S608 to S611 are the same as the processes of S106 to S109 in the first embodiment, and therefore the descriptions thereof will be omitted here.

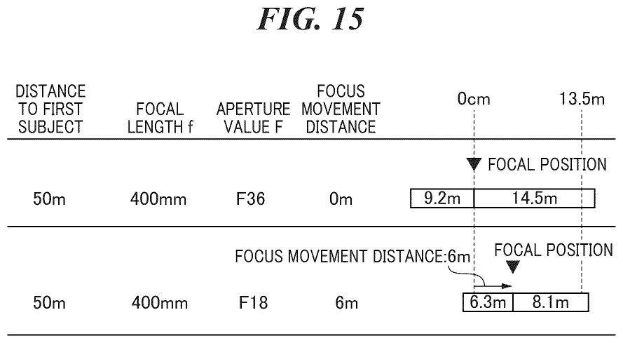

FIG. 15 is a diagram that illustrates a relationship between the F-number and the depth of field in the photographing scene that is shown in FIG. 11A and FIG. 11B. Assuming that the two cars 1301 and 1302 each have a width of about 2 m and a total length of about 4.5 m, when the two cars 1301 and 1302 are competing with each other, the depth of field needs to be approximately three times the total length (about 13.5 m). In the case where the front end of the close-range car 1301 is in focus, the aperture value for keeping the cars 1301 and 1302 within the range of the rear depth of field is F36. Since a depth difference between the cars 1301 and 1302 is capable of being obtained by the aperture and focal position adjustment processing performed in S607 (the processing according to the flowchart of FIG. 14), for example, the focal position is caused to move 6 m from the front end of the car 1301 toward the distant-range side. By doing so, at an aperture value of F18, the front depth of field and the rear depth of field become 6.3 m and 8.1 m, respectively (total 14.4 m), and the cars 1301 and 1302 are capable of being kept within the range of the depth of field.

In the photographing operation according to the second embodiment that has been described above, even in the case where a plurality of moving bodies have been detected as subjects in the depth direction, positions of the plurality of moving bodies are predicted, and the plurality of moving bodies are photographed in the state, in which the aperture is opened as wide as possible, while the plurality of moving bodies are kept within the range of the depth of field. In this case, the detection of hierarchical characteristic regions is performed for each of the plurality of subjects, and a focus area is determined from among the detected hierarchical characteristic regions. As a result, it is possible to obtain a high-quality image that has been focused on a part desired by the photographer. In addition, by opening the aperture as wide as possible, the shutter speed is capable of being increased, so that an image with an appropriate out-of-focus effect, in which the blur of the subject has been reduced (the subject is captured clearly), is capable of being obtained.

The present disclosure has been described above in detail based on its preferred embodiments, but the present disclosure is not limited to these specific embodiments, and various forms that do not depart from the gist of the disclosure are also included in the present disclosure. Furthermore, each of the above-described embodiments merely represents one embodiment of the present disclosure, and each embodiment can be appropriately combined.

For example, in the above-described embodiments, the present disclosure has been described as being embodied as a digital still camera, but the present disclosure is not limited to this and is capable of being applied to electronic apparatuses equipped with an image pickup function that obtains an optical image of a subject obtained by an image pickup optical system as image data by means of an image pickup device (an image sensor). Examples of such electronic apparatuses equipped with the image pickup function (such camera-equipped electronic apparatuses) include camera-equipped portable communication terminals (such as smartphones), tablet PCs, and the like.

According to the present disclosure, it is possible to obtain a photographed image focused on a part desired by the photographer when photographing a plurality of subjects at different positions in the depth direction.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-150807, filed Sep. 2, 2024, which is hereby incorporated by reference herein in its entirety.

What is claimed is:

1. An image pickup apparatus comprising:
at least one processor and/or circuit configured to function as:
a subject detecting unit that detects predetermined subjects from an image obtained by an image pickup unit including an image pickup optical system;
a region detecting unit that hierarchically detects characteristic regions of each of the predetermined subjects;
a selecting unit that selects, from among the predetermined subjects, two subjects that are different in a distance from the image pickup unit in a depth direction;
a determining unit that determines a focus area from among regions hierarchically detected for each of the two subjects;
a control unit that sets an aperture value and a focal position that keep parts of the two subjects corresponding to the focus areas selected by the determining unit within a range of a depth of field; and
a predicting unit that predicts positions of the two subjects in the depth direction after a predetermined period of time has elapsed based on subject image plane positions obtained by past focus detection for the two subjects and defocus amounts obtained by the most recent focus detection for the two subjects.

2. The image pickup apparatus according to claim 1, wherein
the selecting unit selects a close-range subject of the two subjects from among a subject closest to the image pickup unit among the subjects detected by the subject detecting unit, a subject located at a center of the image, and a subject with the largest area in the image.

3. The image pickup apparatus according to claim 2, wherein
the image pickup optical system includes a lens and an aperture, and
the control unit sets the aperture to an open value and focuses on the close-range subject, and then determines whether or not the two subjects are within the range of the depth of field in a state in which the aperture has been narrowed to a specified aperture value.

4. The image pickup apparatus according to claim 3, wherein
in a case where the control unit determines that the two subjects are not within the range of the depth of field when the aperture has been set to the specified aperture value, the control unit sets the aperture to the open value and focuses on the close-range subject of the two subjects.

5. The image pickup apparatus according to claim 3, wherein
in a case where the control unit determines that the two subjects are within the range of the depth of field when the aperture has been set to the specified aperture value, the control unit shifts the focal position toward a distant-range side while driving the aperture toward an open side, and determines whether or not the two subjects are within the range of the depth of field.

6. The image pickup apparatus according to claim 5, wherein
in a case where the control unit determines that the two subjects are not within the range of the depth of field, the control unit sets, in photographing conditions, an aperture value and a focal length at which the two subjects immediately before that are determined to be within the range of the depth of field.

7. The image pickup apparatus according to claim 6, wherein
the control unit uses the set aperture value to set a shutter speed and an ISO sensitivity with which a proper exposure is capable of being obtained during photographing.

8. The image pickup apparatus according to claim 1, wherein
the control unit, in a case where an accuracy of predicted positions in the depth direction of the two subjects obtained by the predicting unit is not within a range of predetermined values, focuses on a close-range subject of the two subjects.

9. The image pickup apparatus according to claim 1, wherein
the at least one processor and/or circuit are configured to further function as a storage unit that stores dictionary data in which a type of a specific subject, an upper hierarchy corresponding to entirety of the specific subject, and a part as a lower hierarchy corresponding to a portion of the specific subject have been defined,
the subject detecting unit detects subjects belonging to the type defined in the dictionary data, and
the region detecting unit detects, from the image, as the characteristic regions, a region including the entirety of the specific subject that has been defined as the upper hierarchy and a region including the part that has been defined as the lower hierarchy.

10. An image pickup apparatus comprising:
at least one processor and/or circuit configured to function as:
a subject detecting unit that detects predetermined subjects from an image obtained by an image pickup unit including an image pickup optical system;
a region detecting unit that hierarchically detects characteristic regions of each of the predetermined subjects;
a selecting unit that selects, from among the predetermined subjects, two subjects that are different in a distance from the image pickup unit in a depth direction;
a determining unit that determines a focus area from among regions hierarchically detected for each of the two subjects; and
a control unit that shifts a focal position when focusing on the focus area of a close-range subject of the two subjects toward a distant-range subject side and obtains a minimum aperture value at which the two subjects are within a range of a depth of field.

11. A control method for an image pickup apparatus, the control method comprising:
a step of detecting predetermined subjects from an image obtained by an image pickup unit;
a step of hierarchically detecting characteristic regions of each of the predetermined subjects;
a step of selecting, from among the predetermined subjects, two subjects that are different in a distance from the image pickup unit in a depth direction;
a step of determining a focus area from among regions hierarchically detected for each of the two subjects;
a step of setting an aperture value and a focal position that keep a part corresponding to the focus area determined for each of the two subjects within a range of a depth of field; and
a step of predicting positions of the two subjects in the depth direction after a predetermined period of time has elapsed based on subject image plane positions obtained by past focus detection for the two subjects and defocus amounts obtained by the most recent focus detection for the two subjects.

12. A control method for an image pickup apparatus, the control method comprising:
a step of detecting predetermined subjects from an image obtained by an image pickup unit;
a step of hierarchically detecting characteristic regions of each of the predetermined subjects;
a step of selecting, from among the predetermined subjects, two subjects that are different in a distance from the image pickup unit in a depth direction;
a step of determining a focus area from among regions hierarchically detected for each of the two subjects; and
a step of shifting a focal position when focusing on the focus area of a close-range subject of the two subjects toward a distant-range subject side and obtaining a minimum aperture value at which the two subjects are within a range of a depth of field.

13. A non-transitory computer-readable storage medium storing a program for causing a computer to execute a control method for an image pickup apparatus, the control method comprising:
a step of detecting predetermined subjects from an image obtained by an image pickup unit;
a step of hierarchically detecting characteristic regions of each of the predetermined subjects;
a step of selecting, from among the predetermined subjects, two subjects that are different in a distance from the image pickup unit in a depth direction;
a step of determining a focus area from among regions hierarchically detected for each of the two subjects;
a step of setting an aperture value and a focal position that keep a part corresponding to the focus area determined for each of the two subjects within a range of a depth of field; and
a step of predicting positions of the two subjects in the depth direction after a predetermined period of time has elapsed based on subject image plane positions obtained by past focus detection for the two subjects and defocus amounts obtained by the most recent focus detection for the two subjects.

14. A non-transitory computer-readable storage medium storing a program for causing a computer to execute a control method for an image pickup apparatus, the control method comprising:
a step of detecting predetermined subjects from an image obtained by an image pickup unit;
a step of hierarchically detecting characteristic regions of each of the predetermined subjects;
a step of selecting, from among the predetermined subjects, two subjects that are different in a distance from the image pickup unit in a depth direction;
a step of determining a focus area from among regions hierarchically detected for each of the two subjects; and
a step of shifting a focal position when focusing on the focus area of a close-range subject of the two subjects toward a distant-range subject side and obtaining a minimum aperture value at which the two subjects are within a range of a depth of field.
